(19) United States
(12) Patent Application Publication
(10) Pub. No.: US 2025/0110091 A1
(43) Pub. Date: Apr. 3, 2025

(54) MODULAR LIQUID CHROMATOGRAPHY SYSTEM

(71) Applicant: Metrohm AG, Herisau (CH)

(72) Inventors: Roland STÖRI, Flawil (CH); Thomas HARTMANN, Gossau (CH); Daniel ABDERHALDEN, Waldkirch (CH); Christian PREISIG, Schwellbrunn (CH); Matthias ROHNER, Widnau (CH)

(73) Assignee: Metrohm AG, Herisau (CH)

(21) Appl. No.: 18/730,127

(22) PCT Filed: Jan. 12, 2023
(86) PCT No.: PCT/EP2023/050638

§ 371 Date: Jul. 18, 2024

(30) Foreign Application Priority Data
Jan. 18, 2022 (EP) 22151909.3

(51) Int. Cl. G01N 30/88; B01D 15/10; G01N 30/20; G01N 30/46

(52) U.S. Cl. CPC G01N 30/88; B01D 15/10; G01N 30/20; G01N 30/46; G01N 2030/8804; G01N 2030/8881

(57) ABSTRACT

The invention relates to an automatic liquid chromatography system (1) with at least one fluid handling unit(s) (2), which is (are) provided as exchangeable, modular component(s). The system (1) further comprises at least one extension carrier (3) with at least one, preferably frameless, component position (C, C′, D, D′, E) for receiving at least one fluid handling unit (2). The system also comprises a base plate (6) and/or a cover plate (4). The at least one extension carrier (3) has at least one mechanical connecting element (15) and the at least one mechanical connecting element (15) projects from one plane into an adjacent plane during intended use, wherein the planes are selected from: extension carrier (3), cover plate (4) and base plate (6).

The invention relates to an automatic liquid chromatography system with extension carrier and extension carrier for such a system for modular expansion of a liquid chromatography system.

There is a wide range of liquid chromatography systems for laboratories that include a number of fluid handling units, e.g. one or more pumps, valves, mixers, sensor units, etc. These fluid handling units are interconnected by fluid lines in the form of rigid or flexible tubing or similar. Although some systems may be designed for a specific type of application with a specific flow path, there is often a need for flexibility and the ability to change or optimize the fluid flow path of the system. Upgrade kits are often supplied as external ancillary equipment that must be located alongside the original system, increasing the floor area of the system. These must be connected to the system both fluidically and electrically (i.e. to a system control bus or similar). In addition, replacing defective fluid handling units is a time-consuming and delicate task.

There are attempts in the state of the art to counteract the lack of flexibility of these systems. For example, WO 2010/144037 A1 describes a chromatography device with interchangeable modular components within a fixed housing. However, the system has the disadvantage that the housing itself cannot be extended. Standardized, fixed positions are allocated for the interchangeable components, so that the components are required to be of a fixed size.

A system similar to WO 2010/144037 A1 is described in WO 2013/028828 A1. The system disclosed there comprises a fixed mounting frame with a series of mounting positions for holding the individual modules. In this system, the size and position are also predefined by the frame arrangement.

It is an objective of the invention to overcome the disadvantages of the prior art. In particular, it is an objective of the invention to provide a flexible liquid chromatography system which can be expanded as required without the individual fluid handling units having to be predetermined in size and dimension.

The problem is solved by the independent claims. Alternative embodiments can be found in the dependent claims.

One aspect of the invention relates to an automatic liquid chromatography system. The liquid chromatography system is arranged to direct a flow of fluid to and from a chromatography separation device. The system comprises at least one, preferably a plurality of, fluid handling unit(s) provided as interchangeable modular component(s). The at least one fluid handling unit is connected or connectable to a liquid chromatography fluid pathway. The at least one fluid handling unit can have at least one data carrier, in particular a microcontroller or microchip, on which characteristic data of the fluid handling unit can be stored or are stored. Optionally, operating signals received from outside the unit can be transmitted to the fluid handling unit and stored. In the case of several fluid handling units, it is possible that there is only one data carrier in total, or two or more. For example, it is conceivable that each fluid handling unit has a data carrier or that two or more fluid handling units can be connected or are connected to the same data carrier.

The system further comprises at least one, preferably two or more, extension carriers with at least one, preferably frameless, component position for receiving at least one, preferably two or more, fluid handling units.

The term “frameless” means in particular that no additional separating device is provided between the individual component positions.

The at least one extension carrier has an open front side for inserting the at least one fluid handling unit. Each component position can have a signal connection via which the at least one data carrier of a fluid handling unit located in the component position can be read out. In particular, a connection can be established with the microcontroller or microchip of a fluid handling unit located in the component position.

The system also comprises a base plate and/or a cover plate.

The at least one extension carrier also has at least one mechanical connecting element. When used as intended, the at least one mechanical connecting element protrudes from one plane into an adjacent plane, whereby the planes are selected from: extension carrier, cover plate and base plate. The adjacent plane can be the next higher plane if the planes are on top of each other and/or a horizontally adjacent plane if the planes are arranged next to each other.

The at least one mechanical connecting element is used in particular to connect a further extension carrier or a cover plate or a base plate.

Such a liquid chromatography system is characterized on the one hand by its compact design, but on the other hand it can be extended as required. This means that the system can be adapted to the available space without compromising on functionality. Such a liquid chromatography system is therefore equally suitable for both small and large laboratories. The mechanical connecting element enables a particularly stable arrangement between the different planes.

The compact design also enables the use of shorter flow paths, resulting in lower dead volumes and shorter analysis times.

The liquid chromatography fluid path is to be understood in particular as the path and the connections between reagents, sam-ple(s), eluents and waste.

The liquid chromatography system can comprise two or more extension carriers which, when used as intended, can be stacked vertically in such a way that the at least one mechanical connecting element projects from one extension carrier into an adjacent extension carrier.

The arrangement can be extended vertically as required and is particularly stable thanks to the mechanical connecting elements.

The at least one extension carrier can preferably be stacked vertically when used as intended in such a way that the at least one mechanical connecting element projects from the at least one extension carrier into an adjacent base plate and/or cover plate.

Advantageously, at least two fluid handling units are arranged or can be arranged horizontally next to each other in the component positions in the at least one extension carrier when used as intended.

The protruding mechanical connecting element can be a screw, a threaded rod, a clip, a bolt, a pin, a nail, a hook, a clamp, a spring, a rivet, a profile, an angle, a flap, in particular a perforated flap, a hinge, a rail or a magnet. The adjacent extension carrier and/or cover plate and/or base plate preferably has a female counterpart, in particular an internal thread, recesses, indentations, bushing, sleeve, profile, dowel, eyelet, cam, groove, magnet.

Furthermore, the liquid chromatography system can additionally comprise an automatic sampler. Compared to conventional systems, the present system is so compact that the automatic sampler can be easily integrated into the system without requiring additional space.

Preferably, the cover plate also has a reagent organizer. This allows the reagents to be stored on the system in a space-saving manner. This also increases the capacity of the reagent bottles compared to conventional systems, which enables longer service lives without user intervention.

The fill level in the reagent containers is preferably measured using ultrasonic distance sensors, which do not have to be located centrally in the containers. This makes it possible, for example, to use stirrers without affecting the distance measurement. Contactless, continuous and accurate measurement of milli-liters is possible.

Preferably, each extension carrier has the same standard front height or an integer multiple thereof and each extension carrier has the same standard front width or an integer multiple thereof. A cuboid extension carrier is particularly preferred.

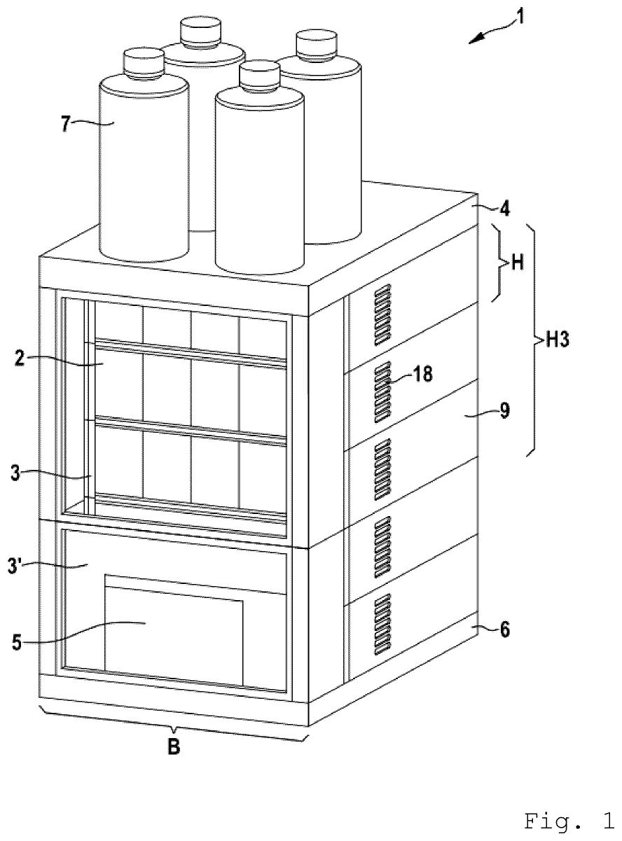

Standard sizes or multiples thereof have the advantage that, for example, the same components can be used for the cladding, e.g. doors or side panels. This is explained again with reference to FIG. 1.

Each extension carrier can have a power supply unit. This means that the electrical power and the number of extensions can be scaled as required.

One or more component positions per extension carrier are preferably shortened in the insertion direction of the fluid handling unit compared to the maximum component position depth. This pro-vides space, in particular to provide a corresponding power supply unit.

It is possible for an extension carrier to have one or more shortened component positions as well as one or more component positions with maximum component position depth. Preferably, the ratio of the maximum component position depth to the shortened component position depth is between 1.3:1 and 1.1:1, preferably 1.2:1. For example, the maximum depth can be 330 mm and the shortened depth of the component position 275 mm.

The at least one extension carrier can have a cooling channel, a central control node and/or a fan in addition to the fluid handling units. In particular, these can be adjacent to the shortened component positions.

Preferably, a fluid guide, in particular a hose, can be guided along a side panel (9) that extends over one or more extension carriers (3).

Preferably, a gap is formed between the extension carrier and the inside of a side panel, through which the fluid guide can be guided; or a recess is provided in a door module associated with the side panel, through which the fluid guide can be guided. It is also conceivable that mounting rails are provided for guiding fluid guides or other accessories, as will be explained in more detail below.

The inflow lines can be guided along one side panel stack and the outflow lines can be guided along the opposite side panel stack.

The reagent and solvent inlet hoses can preferably be attached to the side panels of the extension carriers.

It is also possible for the cover plate to have one or more hose feed-throughs. Preferably, the hose feed-throughs are designed in such a way that a hose together with a coupling, so-called fittings, can be fed through. The fittings can, for example, be of the M6 or fingertight type, which are usually used in high-per-formance chromatography. However, other types familiar to the specialist are also possible.

The at least one fluid handling unit can have a temperature control body, which can act as a heating or cooling body, which protrudes into a cooling channel when used as intended. The temperature control body can comprise so-called heat pipes, which are connected, for example soldered, to cooling fins. The heat pipes and the cooling fins are preferably part of the fluid handling unit. When the fluid handling unit is positioned in the extension carrier, the cooling fins can protrude into the cooling channel of the extension carrier. As an alternative to heat pipes, other thermally conductive elements can also be used.

The arrangement enables particularly efficient temperature control, especially cooling, of the unit. This means that the analysis results are not influenced or even falsified by temperature differences between the units. The temperature can be controlled particularly efficiently. The susceptibility to errors, for example in the baseline in the chromatogram, is significantly re-duced.

Each extension carrier can have a stop door, whereby several stop doors stacked on top of each other when used as intended can be connected to each other. This ensures consistency in the base line despite the frameless design. The system is less susceptible to external temperature differences, draughts and the like.

It is also conceivable to provide a stop door that extends over two or more stacked extension carriers.

The stop doors can be symmetrical so that they can be mounted as left-opening or right-opening. This means that as few different parts as possible are required for the liquid chromatography system. More standardized components enable cost-efficient produc-tion and easier replacement.

The door hinges can be set back from the open front of the extension carrier in the direction in which the fluid handling units are inserted. This allows easier access to the units.

The term “open front” refers to the vertical plane defined by the front of the components projecting furthest into the room.

The fluid handling units are preferably selected from the group: pump, in particular high-pressure pump or peristaltic pump; dosing unit; multi-way valve; separation column; detector; sample preparation unit; suppressor.

The side panels of an extension carrier are preferably designed in such a way that an air flow can be generated transverse to the direction in which the fluid handling units are inserted. This can be achieved, for example, by a fan and intake openings, in particular a perforated grid in the side panel.

Preferably, the air flow transverse to the insertion direction is a branch from a main flow direction, which preferably runs at least partially parallel to the insertion direction of the fluid handling units.

The liquid chromatography system according to the invention preferably has the following sequence of air flow elements:
suction openings, preferably in a side panel;
Fan;
one or more cooling channels;
optional: a power supply unit.

As an alternative to suction openings in the side panel, gaps can also be provided between the side panel and a metal sheet, preferably aluminum sheet, of each extension carrier.

Each extension carrier can comprise at least one fan and one cooling fin block. The cooling fin block can optionally be attached to the extension carrier itself or to the fluid handling unit.

The liquid chromatography system can comprise a central control node in at least one extension carrier. The control node, if present, can be provided in a main extension carrier or in each extension carrier separately. The main extension carrier refers to the extension carrier that can centrally control all units via the control node.

Further, the fluid chromatography system may include software that communicates with the at least one central control node and with the microcontrollers or microchips of the fluid handling unit located in the component position.

The software can be programmable to
(1) recognize the fluid handling units and their component positions;
(3) coordinate the fluid handling units into a flow scheme;
(4) assist the user in making fluid connections between fluid handling units by means of a graphical user interface; and
(5) cause the fluid handling units to direct fluids to and from a chromatography separation device according to a flow proto-col.

Furthermore, one or more vertical drip edges can be arranged between individual fluid handling units. Preferably, these drip edges are separated from the interior of the fluid handling units by seals. This arrangement prevents liquid from running from the wet area into the unit (s).

The system can also have mounting rails. These can also be arranged between the individual fluid handling units, for example, and are primarily used to attach accessories and hoses. An arrangement below the vertical drip edges is particularly preferred, so that drops can be directed from the drip edge into the mounting rail and are thus also kept away from the inside of the unit(s).

A mounting rail extends horizontally along one or more fluid handling units, which is particularly preferred. The mounting rail can extend along the installation direction and/or transverse to the installation direction of the fluid handling units. The seal can be fitted above and/or below the mounting rail and extend over the entire length of the mounting rail. However, it is also possible that only individual seals are fitted in the areas of the drip edges.

This sealing arrangement also supports the essentially frameless assembly of the system.

Furthermore, the liquid chromatography system can demonstrate electromagnetic compatibility (EMC) after positioning the at least one fluid handling unit in the at least one extension carrier. In particular, the design enables the provision of frameless components, which nevertheless fulfill the EMC requirements when installed.

EMC is defined as the ability of an electrical device to function satisfactorily in its electromagnetic environment without inad-missibly influencing this environment, which may also include other devices.

EMC covers both interference immunity and the limitation of emit-ted interference; it is divided into individual sub-areas, e.g. radio interference, discharges of static electricity, electromagnetic fields and fast transient interference. The relevant EMC standards and guidelines known to the specialist should be ob-served. For example, these may include EN 61326-1 and EN 61000-6-3/4 for interference emissions and EN 61326-1 and EN 6100-6-1/2 for interference immunity.

Another aspect of the invention relates to an extension carrier for an automatic liquid chromatography system as described above. The extension carrier comprises:
at least one, preferably frameless, component position for holding at least one fluid handling unit;
an open front side for the insertion of at least one fluid handling unit;
optionally one signal connection per component position, via which a data carrier of a fluid handling unit located in the component position can be read out, in particular a connection can be established with the microcontroller or microchip of a fluid handling unit located in the component position;

The extension carrier has at least one mechanical connecting element that can project into an adjacent vertical plane.

The extension carrier can have two or more frameless component positions for holding two or more fluid handling units. Two or more fluid handling units can be arranged side by side in the component positions in the extension carrier in a horizontal plane when used as intended.

The invention is explained in more detail below with reference to the figures. The figures merely show preferred embodiments and are not to be understood as limiting. Identical reference signs indicate identical elements. The figures show:

FIG. 1: A liquid chromatography system according to the invention with several extension carriers in a perspective view.

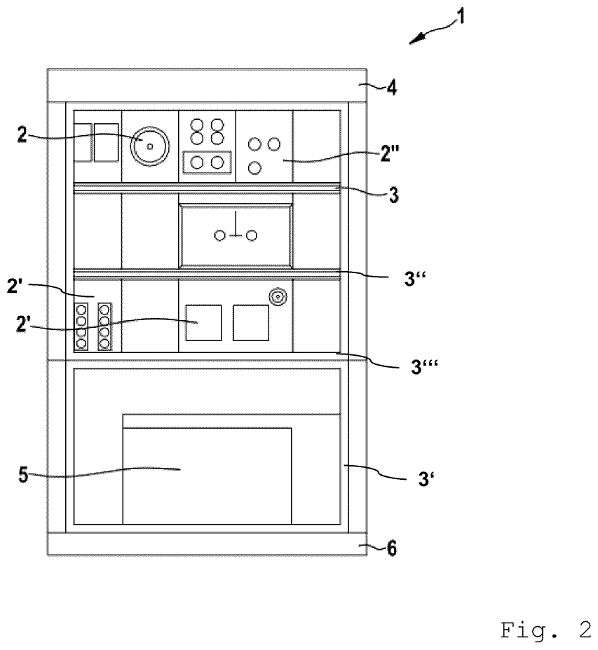

FIG. 2: Front view with details of the liquid chromatography system according to the invention shown in FIG. 1.

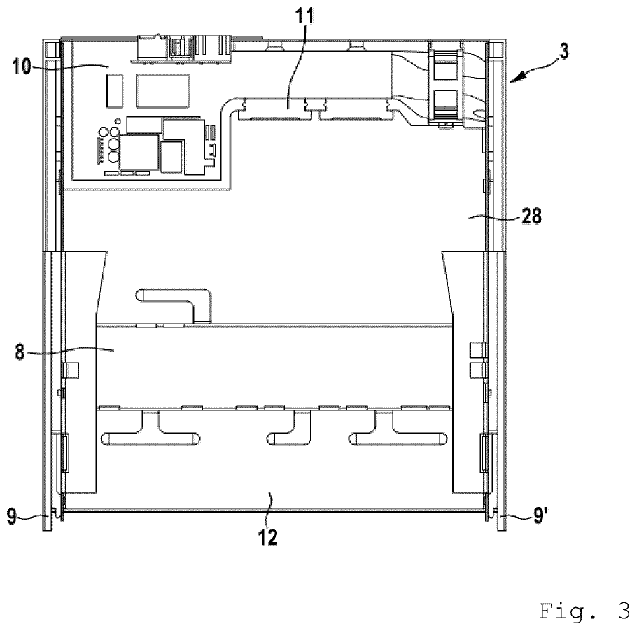

FIG. 3: shows a plan view of an extension carrier according to the invention.

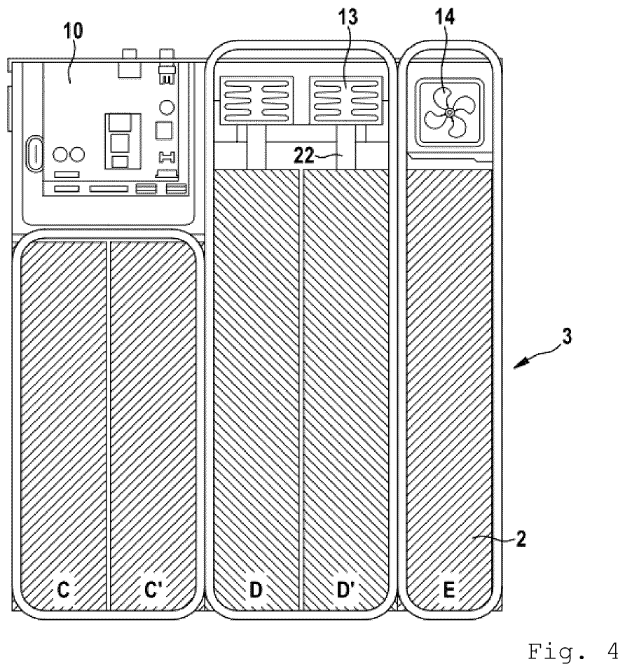

FIG. 4: shows an example of a possible arrangement of different fluid handling units in an extension carrier.

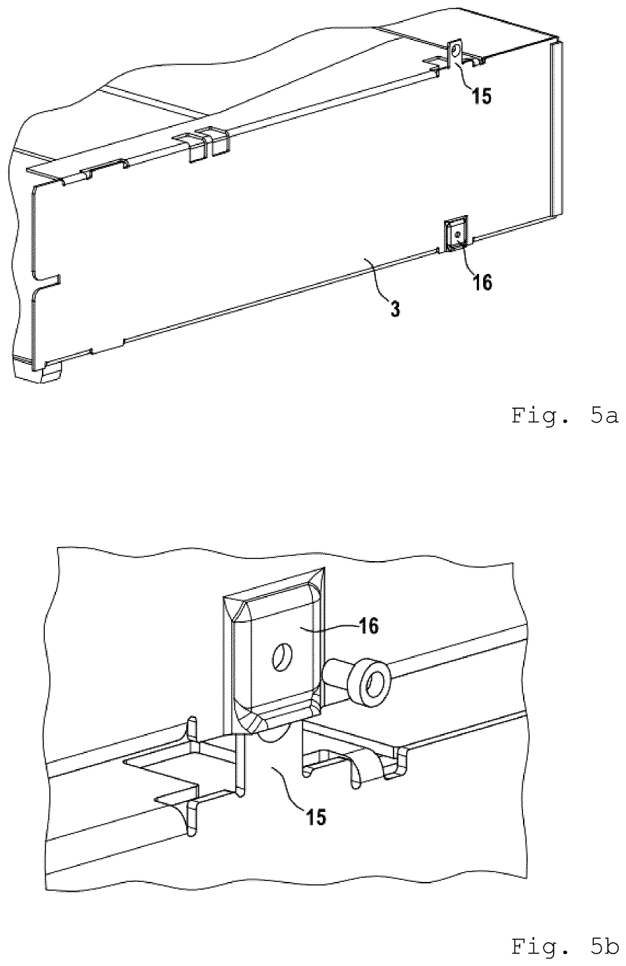

FIG. 5a, shows an exemplary arrangement of a mechanical connecting element,

FIG. 5b: shows a detailed view of the mechanical connecting element for connecting adjacent extension carriers.

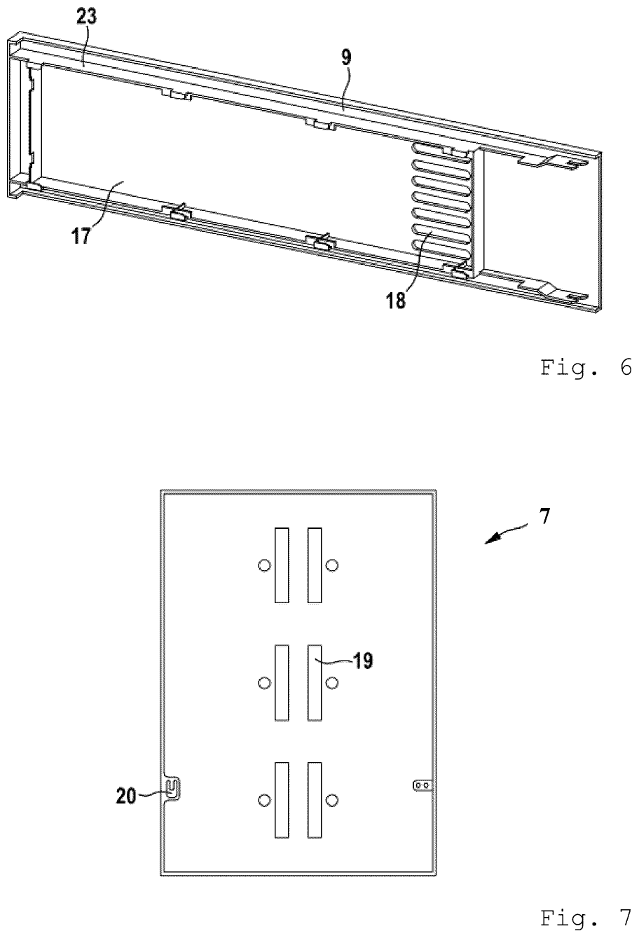

FIG. 6: shows an example of a side panel.

FIG. 7: shows a top view of a reagent organizer.

FIG. 8: shows a detailed view of a hose feed-through.

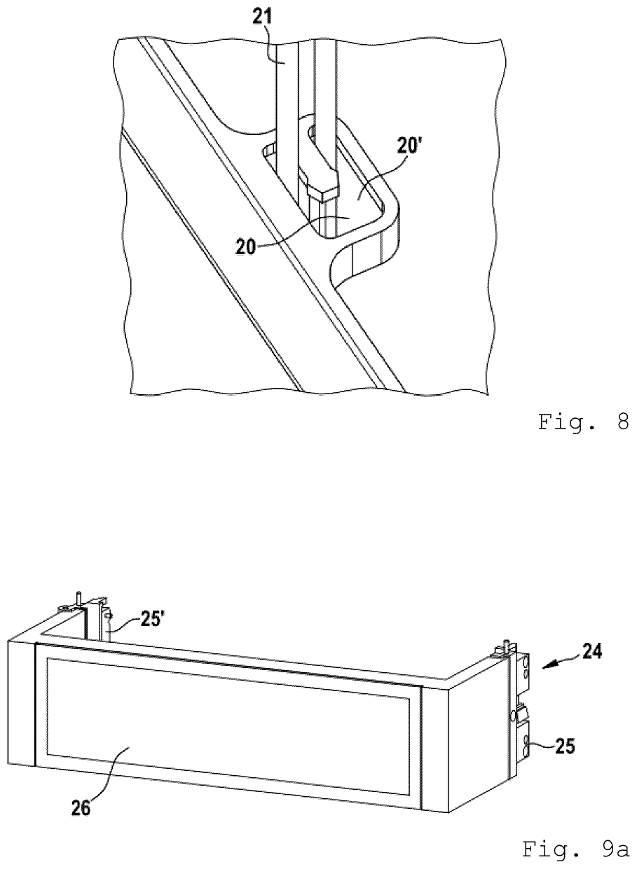

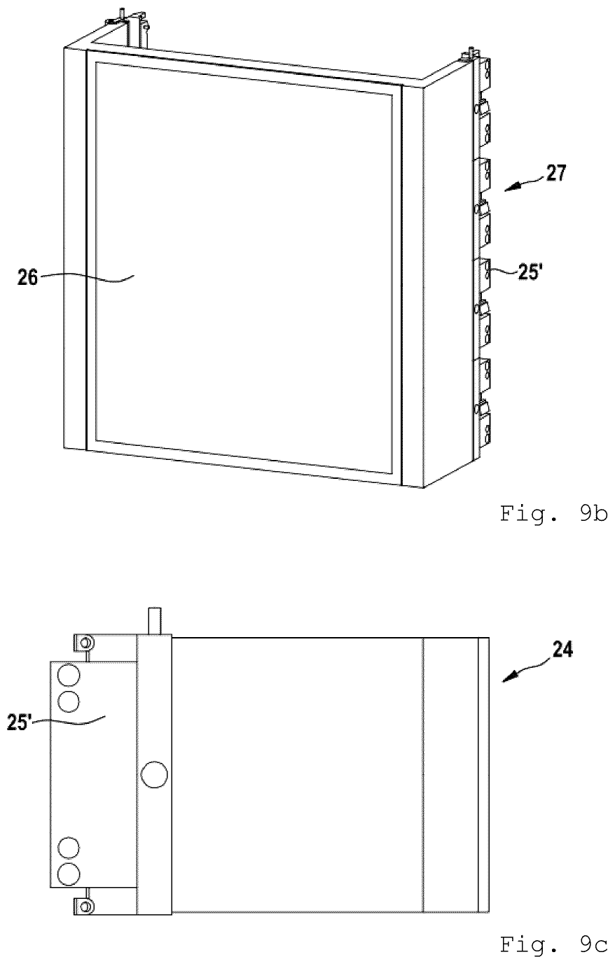

FIG. 9a: shows a single-story stop door.

FIG. 9b: shows a multi-story stop door.

FIG. 9c: shows a single-story stop door in section through the pivot point of the hinge.

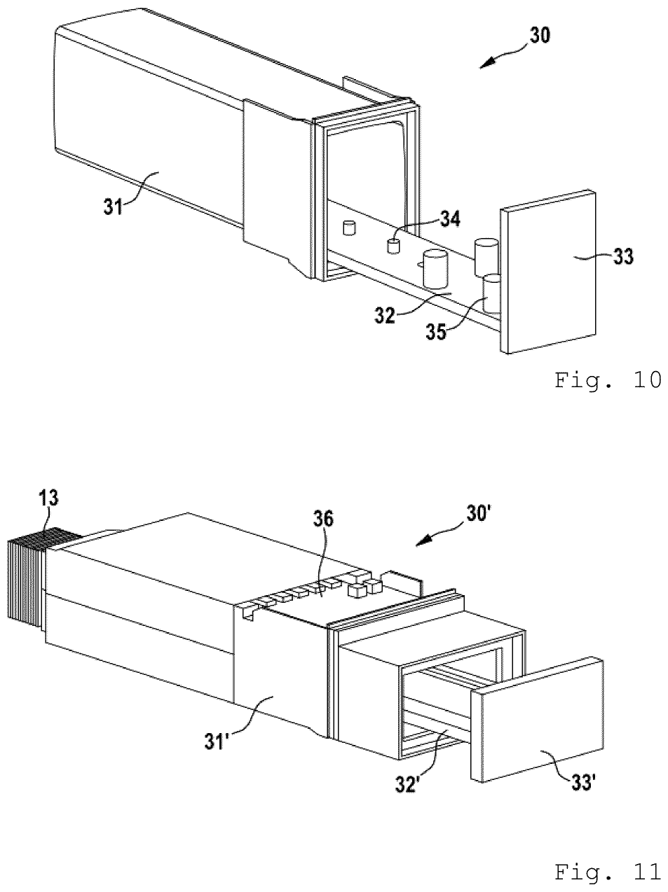

FIG. 10: shows a fluid handling unit.

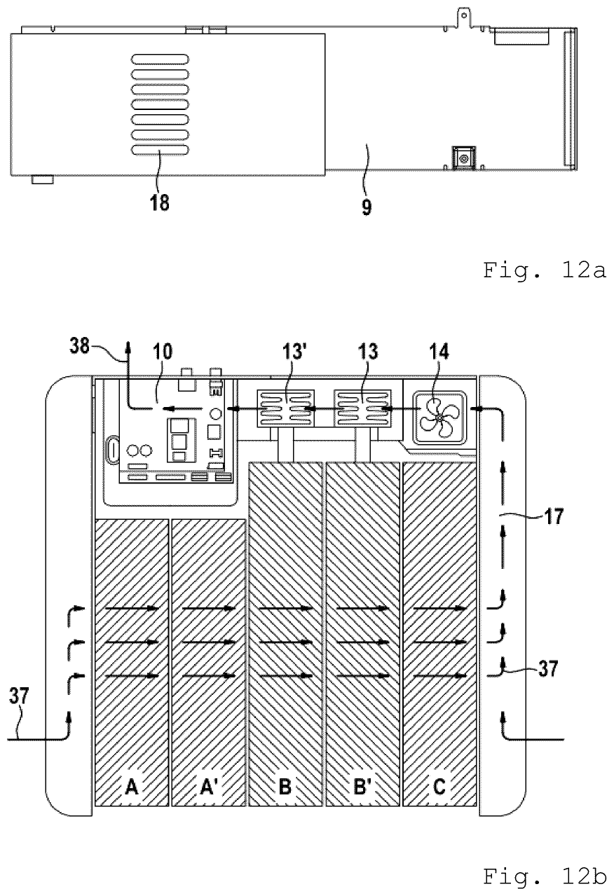

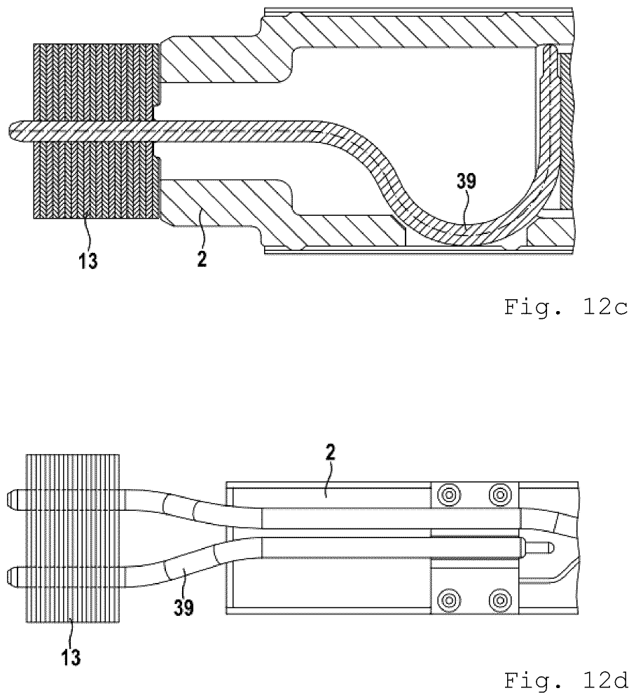

FIG. 11: shows a further embodiment of a fluid handling unit.

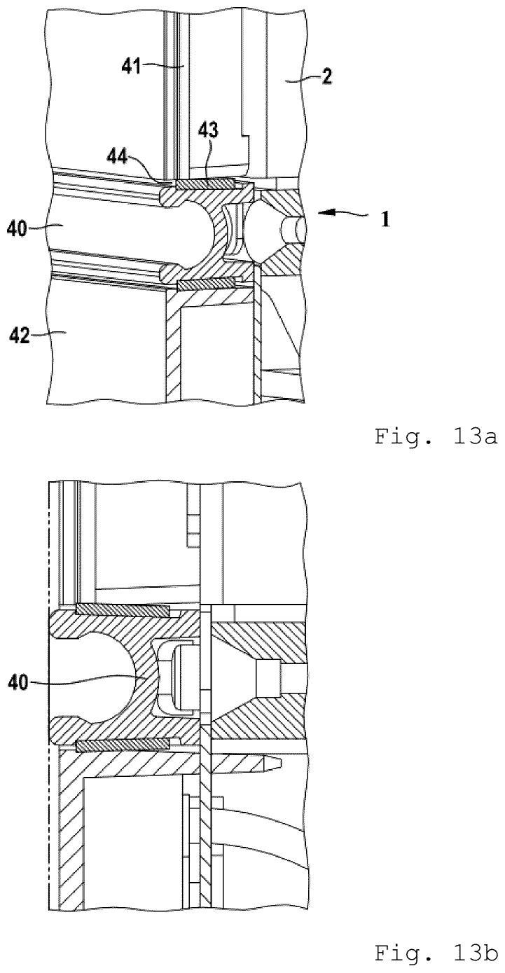

FIG. 12a: shows a side panel with suction openings.

FIG. 12b: shows a path of the air flow.

FIG. 12c: shows a possible design of heat pipes within a fluid handling unit.

FIG. 12d: shows a second configuration of heat pipes within a further fluid handling unit.

FIG. 13a: Leakage liquid collection system with a drip collection rail and an internal vertical drip edge in a perspective view.

FIG. 13b: Side view of the leakage liquid collection system from FIG. 13a.

FIG. 1 shows an example of a liquid chromatography system 1 according to the invention comprising several extension carriers 3 and 3′. The three extension carriers 3 in the upper area each have several component positions for fluid handling units 2 (schematic). A further extension carrier 3′ in the lower area has only one component position for a fluid handling unit 2. In the lower area, the extension unit is equipped with an automatic sampler 5 as a fluid handling unit. The extension carrier 3 has a standard height H and a standard width B. The extension carrier 3′ has the same standard width B, but twice the standard height H of the extension carrier 3. By using standard heights H or widths B or a multiple thereof, e.g. H3, the same components can be used for system 1. For example, no adaptation of the side panels 9 is necessary, as two side panels 9 with standard dimensions can simply be used in the case of the extension carrier 3′. The situ-ation is similar with the doors (not shown). The system also comprises a cover plate 4 and a base plate 6. A reagent organizer 7 with four reagent containers is located on the cover plate 4. In addition, the extension carriers 3, 3′ are covered with side panels 9. The side panels have perforated grids 18 as suction openings.

FIG. 2 shows a front view of the system 1 according to the invention shown in FIG. 1. The uppermost extension carrier 3 has five component positions, four of which are occupied by fluid handling units, for example 2 or 2″. The third extension carrier 3′″ comprises four component positions and is occupied by two fluid handling units 2′.

FIG. 3 shows a plan view of an extension carrier 3 according to the invention. The extension carrier 3 has a sheet metal base 28, a power supply unit 10 and coupling positions 11 for coupling fluid handling units with integrated temperature control or heat sink (not shown). Each component position has a signal connection 8 in the form of a unit switch board (UNSB). The extension carrier also has an open front 12 and side panels 9 and 9′.

FIG. 4 shows an example of a possible arrangement of different fluid handling units 2 within an extension carrier 3. In this example, fluid handling units 2 with heat pipes can only occupy the component positions D and D′. Positions D and D′ are additionally equipped with ventilation ducts 22 and cooling fins 13. Fluid handling units 2 with control node (CN) functionality on the unit switch board can only be positioned in position E. These fluid handling units with CN functionality have their own control unit. Component position E also has a fan 14. Component positions C and C′ are only suitable for fluid handling units with a short design. Component positions D, D′ and E are also suitable for longer designs of the individual fluid handling units 2.

FIGS. 5a and 5b show an example of a mechanical connecting element 15 and the counterpart 16. In particular, FIG. 5a shows a side view of an extension carrier 3 with the connecting elements 15 and 16 and FIG. 5b shows a detailed view of two connecting elements 15 and 16. The mechanical connecting element 15 is designed as a perforated flap. Its female counterpart 16 is designed as a pocket into which the perforated flap is pushed (FIG. 5b). An additional screw can be used to fix it in place.

FIG. 6 shows an example of a side panel 9. This side panel 9 has a perforated grid 18 through which air can be drawn in. The side panel 9 also has struts 23, which form a ventilation duct 17 when the side panel 9 is mounted.

FIG. 7 shows a top view of a reagent organizer 7. Six positions 19 for reagents can be seen. On the left-hand side there is a hose feed-through 20 that can hold up to six hoses or several ca-pillaries. The reagent organizer 7 can be connected to a plane, for example the cover plate or an extension carrier, using four lateral screws.

FIG. 8 shows a detailed view of the hose feed-through 20 with the hoses 21 passing through it. The feed-through 20 is designed so that the hose 21 and coupling can be passed through it. This means that the coupling, for example in the form of an M6 fit-ting, fits particularly well through the uninterrupted part 20′ of the hose bushing 20.

FIG. 9a shows a single-story stop door 24 with a single-story hinge 25. The stop door 24 is symmetrical with a stop 25 on the right in the picture and hinges 25′ on the left in the picture as well as a stop on the left and hinges on the right (not visible in the figure). The doors 24 can therefore be opened to the left or right. Furthermore, the hinged door 24 has a viewing window 26.

FIG. 9b shows a multi-story stop door 27, each of which has a hinge 25′ at the height of a story. The hinges 25′ are again fitted symmetrically on both sides, so that the doors 27 can also be fitted on the left and right in this case and opened accordingly.

FIG. 9c shows a section through the pivot point of the hinge 25′ of a single-action door 24. The door 24 has a slight moment so that the door remains in any opening position and does not open or close freely.

FIG. 10 shows a fluid handling unit in the form of an accessory drawer 30 without control nodes. This can be used in particular to accommodate sample preparation units. The drawer 30 comprises a housing 31 and an extendable element 32 with a front cover 33. The extendable element 32 comprises positioning elements 34 for positioning accessories. The extendable element 32 may also include connectors 35 for fluidly connecting the accessories to the system.

FIG. 11 shows a further embodiment of a fluid handling unit in the form of a further accessory drawer 30′, in particular for a separating column (not shown). The drawer 30′ may have the same elements as described with reference to FIG. 10. In addition, the accessory drawer 30′ may comprise an electronic circuit 36, which is preferably located at the top and at the front part of the housing 31′. The arrangement of the electronics in this position simplifies the electronic link to the system.

FIGS. 12a to 12d explain the temperature control in more detail. FIG. 12a shows a side panel 9 with a perforated grid 18. The holes in the perforated grid 18 serve as an intake opening to guide cooling air through the housing.

A possible cooling air flow 37 is shown schematically in FIG. 12b. The main air flow 37 does not pass transversely through the housing, but only inside the cooling channel 17. The air 37 is drawn in at the front right via the perforated grid 18 in the side panel 9. On its way to the fan 14 towards the rear, the air flows over the side wall of the shelf plate (indicated schematically by the transverse arrows) and cools the side wall of the shelf plate. After the fan 14, the air flows through the two cooling fin blocks 13. The heated air is still cold enough to cool the power supply unit 10 before leaving the duct as exhaust air 38. Cooling is achieved here by means of forced convection through the fan 14.

FIGS. 12c and 12d show additional heat pipes 39 within various fluid handling units 2 connected to a cooling fin block 13.

FIG. 13a shows an embodiment example of a possible leakage liquid collection system to prevent liquid from collecting inside the liquid chromatography system. Here, a mounting rail 40 for accessories, e.g. hoses, is mounted horizontally between fluid handling units 2 of the liquid chromatography system 1. The fluid handling units 2 comprise vertical drip edges 41, via which liquid escaping due to leakage is first directed into the mounting rail 40 and then further over its edge and thus past the individual components of the system. An additional seal 43 prevents wa-ter from entering the system. A side view of the mounting rail shows an inverted C-profile. The side profile is shown again in FIG. 13b.

1. An automated liquid chromatography system arranged to direct a flow of fluid to and from a chromatography separation apparatus, the system comprising:
at least one fluid handling unit(s) provided as interchangeable, modular component(s),
wherein the at least one fluid handling unit is connected or connectable to a liquid chromatography fluid pathway; and
at least one extension carrier with at least one component position(s) for receiving at least one fluid handling unit(s),
wherein the at least one extension carrier has an open front side for inserting the at least one fluid handling unit(s);
a base plate and/or a cover plate;
wherein the at least one extension carrier has at least one mechanical connecting element and the at least one mechanical connecting element projects from one plane into an adjacent plane when used as intended, the planes being selected from: extension carrier, cover plate and base plate.

2. The liquid chromatography system according to claim 1, wherein the at least one fluid handling unit has at least one data carrier on which characteristic data of the fluid handling unit can be stored or are stored.

3. The liquid chromatography system according to claim 2, wherein each of the component position has a signal connection via which the at least one data carrier of a fluid handling unit located in the component position can be read out.

4. The liquid chromatography system according to claim 1, wherein the system comprises two or more extension carriers which, when used as intended, are vertically stackable such that the at least one mechanical connecting element projects from one extension carrier into an adjacent extension carrier.

5. The liquid chromatography system according to claim 1, wherein the at least one extension carrier can be stacked vertically when used as intended in such a way that the at least one mechanical connecting element projects from the at least one extension carrier into an adjacent base plate and/or cover plate.

6. The liquid chromatography system according to claim 1, wherein at least two fluid handling units are arranged or can be arranged horizontally next to each other in the component positions in the at least one extension carrier when used as intended.

7. The liquid chromatography system according to claim 1, wherein each extension carrier has the same standard front height or an integer multiple thereof and each extension carrier has the same standard front width or an integer multiple thereof.

8. The liquid chromatography system according to claim 1, wherein each extension carrier comprises a power supply unit.

9. The liquid chromatography system according to claim 1, wherein the at least one extension carrier comprises a cooling channel, a central control node and/or a fan to the fluid handling units.

10. The liquid chromatography system according to claim 1, wherein a fluid guide can be guided along a side panel which extends over one or more extension carriers.

11. The liquid chromatography system according to claim 10, wherein
a) a gap is formed between the extension carrier and the inside of a side panel, through which the fluid guide can be guided; or
b) a recess is provided in a door module associated with the side panel, through which the fluid guide can be guided.

12. The liquid chromatography system according to claim 1, wherein the at least one fluid handling unit has a temperature control body, which projects into a cooling channel of the expansion carrier when used as intended.

13. The liquid chromatography system according to claim 1, wherein the at least one fluid handling unit is selected from the group consisting of: pump; dosing unit; multi-way valve; separation column; detector; sample preparation unit; suppressor.

14. The liquid chromatography system according to claim 1, wherein side panels of an extension carrier are designed such that an air flow can be generated transversely to the direction of introduction of the fluid handling units.

15. The liquid chromatography system according to claim 1, wherein the following sequence consists in the arrangement of air flow elements:
suction openings;
Fan;
one or more cooling channels;
Optional: a power supply unit.

16. The liquid chromatography system according to claim 1, wherein one or more vertical drip edges are arranged between the fluid handling units.

17. The liquid chromatography system according to claim 16, wherein the drip edges are separated from an interior of a fluid handling unit by seals.

18. The liquid chromatography system according to claim 1, wherein the system further comprises mounting rails for attaching fluid guides and/or accessories.

19. An extension carrier for an automatic liquid chromatography system according to claim 1, comprising:
at least one component position for receiving at least one fluid handling unit;
an open front side for the insertion of the at least one fluid handling unit;
wherein the extension carrier has at least one mechanical connecting element which can project into an adjacent vertical plane.

20. The extension carrier according to claim 19, wherein for each component position a signal connection, via which a data carrier of a fluid handling unit located in the component position can be read out.

21. The extension carrier according to claim 19, wherein the extension carrier has two or more frameless component positions for receiving two or more fluid handling units and wherein two or more fluid handling units can be arranged next to each other in the component positions in the extension carrier in a horizontal plane when used as intended.
